(19) United States
(12) Patent Application Publication
(10) Pub. No.: US 2007/0128412 A1
(43) Pub. Date: Jun. 7, 2007

(54) Structure of an electromagnetic shield layer for a plasma display panel and method for manufacturing the same

(76) Inventors: Ching-Yu Tso, Taipei City (TW); Hsiou-Jeng Shy, Sanchong City (TW); Hsien-Ming Wu, Longtan Township (TW); Wen-Yung Shu, Hsin-Tien City (TW); Joseph Cheng, Kuan-Yin Industry Park (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/416,159

(22) Filed: May 3, 2006

(30) Foreign Application Priority Data
Dec. 2, 2005 (TW) 094142404

(51) Int. Cl. B32B 3/00

(52) U.S. Cl. 428/172

(57) ABSTRACT

A structure of an electromagnetic shield layer for a plasma display panel and a method for manufacturing the same. The manufacturing method of the electromagnetic shield layer uses integrated technologies of hot embossing, coating, and electroplating. The structure according to the present invention is a metal layer with an electromagnetic-wave shielding effect and is built in a plastic material. The aspect ratios of the geometric patterns on the metal layer are above 75%.

### FIELD OF THE INVENTION

The present invention relates generally to a structure of an electromagnetic shield layer and a method for manufacturing the same, and particularly to a structure of an electromagnetic shield layer for a plasma display panel and a method for manufacturing the same. The electromagnetic shield layer is adapted on the front surface of the display to shield electromagnetic-wave radiations. Thereby, the class B specification for home applications can be complied with, and impacts on human health can be avoided.

### BACKGROUND OF THE INVENTION

With the advancements of technologies, the United States will start to switch to digital televisions. When the time comes, plasma display panels will become popular as consumers enjoy digital television programs. For examples, a plasma television uses the principles of a fluorescent light and a neon light to fill inert gas such as neon (Ne) and xenon (Xe) to a micro duct. The ultraviolet light generated by discharge excites fluorescent powder, and thus the three primary colors for pixels will exhibit. These colors will constitute pixels, and further form a frame. Nevertheless, plasma discharge generates electromagnetic waves. Thereby it is necessary to shield the electromagnetic waves by an electromagnetic shield layer to achieve class B specification of above 40 dB for home applications, and hence to avoid affecting human health.

According to the methods in U.S. Pat. No. 6,090,473 and U.S. Pat. No. 6,262,364 B1, metals or metal oxides are sputtered on a transparent substrate to achieve the function of electromagnetic shielding. However, the manufacturing cost of the sputtering method is high, and the transparency of the substrate reduces as the thickness of the sputtered layer increases. One the other hand, if the thickness of the sputtered layer is reduced, the efficiency of electromagnetic shielding is relatively worse. Thereby, transparency is the main issue of the method. According to the method provided by the U.S. Pat. No. U.S. 6,399,879 , a metal-powder-alike conduction layer is printed directly on a transparent substrate. After being dried off, an electromagnetic shielding effect is formed by thickening the metal layer in terms of electroplating. Owing to limitations of printing lines with precision, it is not possible to manufacture circuits with linewidth below 40 micrometers, which results in wider linewidths and consequently affects the overall transparency. According to the method provided by U.S. Pat. No. U.S. 6,188,174 , a transparent substrate is pre-processed first, and then the metal layer thereof is thickened to a fixed thickness and is coated with thin photoresist to carry out exposure and development. At last, the substrate is etched to produce a product with an electromagnetic shielding effect and with high transparency. However, the investment cost of exposure equipments is costly if the electromagnetic shield layer is produced by lithography. Moreover, there are many process challenges to be conquered. For example, after the photoresist is coated, the substrate has to be softly baked. Copper is prone to slight rolling-up due to different coefficients of thermal expansion with PET, and consequently to increasing the degree of difficulty for subsequent photolithographic processes. In addition, if the linewidth is only 12 micrometers during the etching step, it is a tough challenge for the uniformity of etching, and is vulnerable to the problem of line breaks due to side etching. In the future, if the electromagnetic shield layer in a 102-inch plasma display panel is to be manufactured as the one produced in Korea, equipment investments and technologies will be major problems.

### SUMMARY

The purpose of the present invention is to provide a structure of an electromagnetic shield layer for a plasma display panel and a method for manufacturing the same. By using the electromagnetic shield layer with low equipment investment, low cost, and high quality, the class B specification for home applications can be complied with. Consequently, electromagnetic waves produced by a plasma television are reduced, and hence users' health is maintained.

The other purpose of the present invention is to provide a structure of an electromagnetic shield layer for a plasma display panel and a method for manufacturing the same. The structure and the manufacturing method thereof provide double-side black oxidation. Accordingly, the influence of light reflection by environments can be avoided.

Normal electromagnetic shield layers are manufactured by lithography process, in which large-scale parallel-light exposure machines and photoresist necessary for the process have to be purchased. With the continuous increase in size of plasma televisions, it is definite that equipment investments and technology will have bottlenecks for manufacturing products above 60 inches. The advantage of the present invention is to use technologies such as hot embossing, coating, and electroplating but not lithography, thereby the cost of parallel-light exposure machine and the costly expanses of photoresist can be saved. In addition, there is no limit on linewidth imposed by equipments. In the future, even if the size of plasma televisions continues to increase above 100 inches, it is not necessary to further expand equipments. Besides, the metal layers in the prior art are protruding on plastic substrates. Because mesh structures tend to produce bubbles or voids on the edges of the protruding metal mesh structures when they are glued with other shield layers for near-infrared and orange-red lights, optical characteristics and adhesion qualities will be affected severely.

According to the present invention, metal layers are built inside plastic substrates. Thus, the problem of producing bubbles and voids when gluing can be prevented. In addition, according to the present invention, because the metal layers are recessed in the structure, the glue for assembly can be coated thinly, and is advantageous for thinning the whole structure as well as for the penetrating light. Because the conduction layer is a black oxidation layer itself, and because the metal layers are built inside the plastic substrates, it is only necessary to carry out black oxidation process to the surface of the metal layer then double-side black oxidation is generated. Thus, the influence of light reflection by environments can be avoided effectively. Consequently, optical characteristics and adhesion qualities are both excellent. Thereby, the product according to the present invention is far superior to the product according to the prior art both in quality and in cost.

The feature of the present invention is to use hot embossing, coating, and electroplating technologies to manufacture a metal layer built inside a substrate of plastic material and having electromagnetic-wave shielding effect, and thus to provide excellent optical transparency characteristics as well as electromagnetic-wave shielding capabilities. The geometric pattern of the metal layer of the electromagnetic shield layer comprises 50 -micrometer or narrower linewidths, and 150 -micrometer or wider line pitches, such that the aspect ratios (the ratios of linewidth to line pitch) are above 75%. In addition, the thickness of the metal layer is between 1 micrometer and 15 micrometers. The materials of the metal layer are composed of copper, nickel, copper alloy or nickel alloy. Besides, the advantage of being built inside the plastic materials is used to generate double-side black oxidation so that the influence of light reflection by environments can be avoided.

The master mold for hot embossing in the manufacturing method of the electromagnetic shield layer according to the present invention can be made using lithography and electroplating, in which nickel-cobalt master molds can be manufactured with linewidths between 6 and 50 micrometers and line pitches between 150 and 500 micrometers, or can be made using laser machining on metal materials. In general, the mater molds can be used for tens of thousand times. In addition, molds are so easy to fabricate that subsequent requests of producing geometric patterns with different or identical depth can be satisfied. A substrate is hot embossed in a hot embossing machine. The substrate includes polymethyl methacrylate (PMMA), polycarbonate (PC), polyethylene terephthalate (PET), polyethyl (PE), methylstyrene (MS), and triacetate cellulose (TAC). With operating temperatures of hot embossing between 100 and 200° C. and pressures between 1000 and 4000 N, a plurality of substrates with trench widths between 6 and 50 micrometers, trench pitches between 150 and 500 micrometers, and depths between 1 and 15 micrometers can be manufactured smoothly. Metal glue is coated to trenches with a scraper, and are heated to 70˜150° C. and dried off to form a conduction layer. The coated conduction layer is formed by metal powder and glue mixed uniformly, wherein the metal powder includes silver, copper, nickel, gold, tin, platinum, palladium, iridium, cobalt, zinc, and alloys of the metal powder. The glue used includes epoxy acrylic glue, silicon glue, polyimide glue, and mixtures of the glue. The electromagnetic-wave shielding effect has been influenced even if only the conduction layer is coated. The shielding efficiency for electric field frequencies of 0˜500MHz is between 21 and 50 dB, and is averaged to 27 dB; the shielding efficiency for electric field frequencies of 500˜1000 MHz is between 15 and 21 dB, and is averaged to 18 dB. The shielding efficiency for magnetic field frequencies of 0˜600 MH is between 3 and 10 dB, and is averaged to 6 dB; the shielding efficiency for magnetic field frequencies of 600˜1000 MHz is between 10 and 20 dB, and is averaged to 15 dB. After electroplating a metal layer, the electromagnetic-wave shielding effect is increased obviously. The material of the metal layer includes copper, silver, nickel, gold, tin, platinum, palladium, iridium, cobalt, zinc, and alloys of these metals. Experiments show that the thicker the metal layer, the better the electromagnetic-wave shielding effect. For example, when the thickness of copper is 2 micrometers, the shielding efficiency for electric field frequencies of 0˜500 MHz is between 32 and 58 dB, and is averaged to 41 dB; the shielding efficiency for electric field frequencies of 500˜1000 MHz is between 25 and 32 dB, and is averaged to 29 dB. The shielding efficiency for magnetic field frequencies of 0˜600 MH is between 14 and 26 dB, and is averaged to 21 dB; the shielding efficiency for magnetic field frequencies of 600˜1000 MHz is between 26 and 40 dB, and is averaged to 36 dB. No matter for electric field or for magnetic field, the shielding efficiencies are much better than with the conduction layer coated only. Furthermore, when the thickness of copper reaches 5 micrometers, the shielding efficiency for electric field frequencies of 0˜500 MHz is between 49 and 53 dB, and is averaged to 51 dB; the shielding efficiency for electric field frequencies of 500˜1000 MHz is between 46 and 66 dB, and is averaged to 54 dB. The overall average for electric field is 53 dB. The shielding efficiency for magnetic field frequencies of 0˜600 MH is between 25 and 37 dB, and is averaged to 33 dB; the shielding efficiency for magnetic field frequencies of 600˜1000 MHz is between 37 and 57 dB, and is averaged to 50 dB. The overall average for magnetic field is 40 dB. According to the results described above, the electromagnetic-wave shielding effect complies with the class B specification of above 40 dB for home plasma display panels. In comparison with the electromagnetic shield layer manufactured using lithography technology, the shielding effect of the electromagnetic shield layer manufactured according to the present invention is better. At last, the electromagnetic shield layer according to the present invention is finished by carrying out a black oxidation process on the surface of the metal layer to avoid the influence of light reflection by environments on optical characteristics. The electromagnetic shield layer of a plasma display panel disclosed in the present invention adopts mainly the processes of hot embossing, coating, and electroplating. The present invention not only saves equipment investments and costs of lithography process, it is far superior to the prior-art lithography process in equipment build-up, process technology, product cost, as well as in product quality.

### BRIEF DESCRIPTION OF THE DRAWINGS

FIGS. 1A to 1D are structural schematic diagrams of fabrication processes for an electromagnetic shield layer according to a preferred embodiment of the present invention; and

FIG. 2 is a photograph of an electromagnetic shield layer according to a preferred embodiment of the present invention.

### DETAILED DESCRIPTION

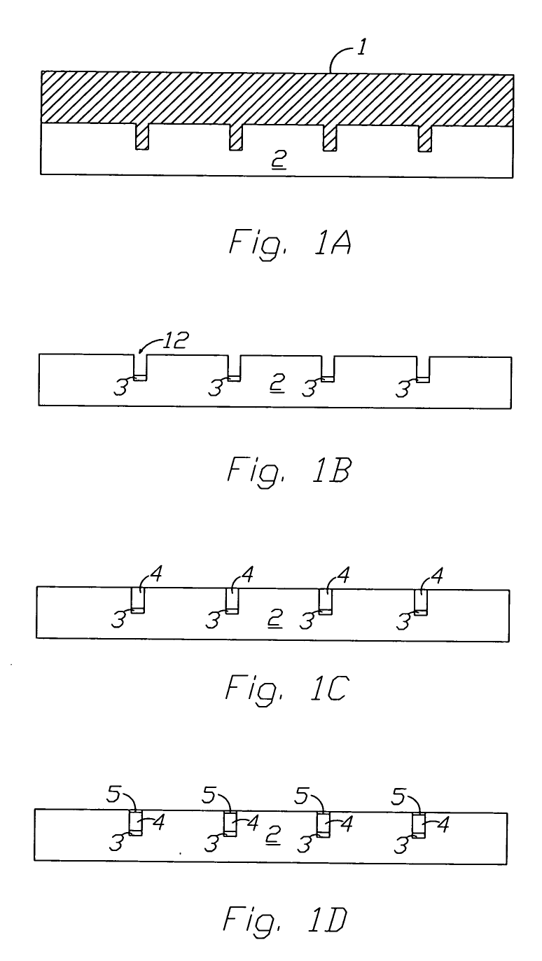

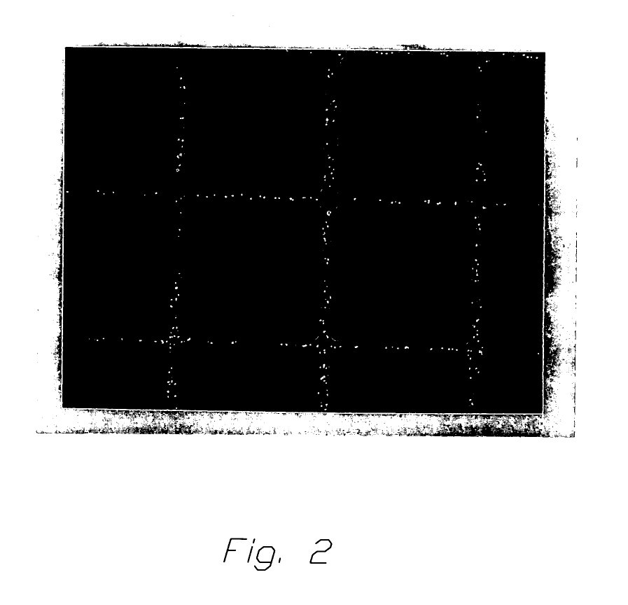

A plurality of trenches is hot embossed on a substrate 2 by a master mold using a hot embossing method. With operating temperatures of the hot embossing method between 100 and 200° C. and pressures between 1000 and 4000 N, a plurality of trenches 12 with trench widths between 6 and 50 micrometers, trench pitches between 150 and 500 micrometers, and depths between 1 and 15 micrometers can be manufactured smoothly. A conduction layer 3 is formed by coating metal powder added with glue to trenches 12 with a scraper, and then is heated to 70˜150° C. and dried off. In terms of the conducting characteristic of the conduction layer 3, a metal layer 4 can be electroplated thereon. At last, a black oxidation layer 5 is formed by carrying out a black oxidation process on the surface of the metal layer 4. Besides, because the conduction layers 3 is a black oxidation layer itself, thereby a double-side black oxidation is formed as shown in FIGS. 1A to 1D. The finished product is shown in FIG. 2. In the follows, embodiments will be provided to describe the feasibility of the present invention, and the shielding efficiencies of the electric and magnetic fields will be analyzed with an electromagnetic-wave shielding tester according to the MIL-STD-285 standard.

### Embodiment 1

### Coated with Silver Glue Products

On a PMMA plastic material, meshed trenches with linewidth of 12 micrometers and line pitch of 290 micrometers using hot embossing method are formed, and a layer of silver glue in the meshed trenches is coated. The electromagnetic-wave shielding effect thereof is as follows. The shielding efficiency for electric field frequencies of 0˜500 MHz is between 21 and 50 dB, and is averaged to 27 dB; the shielding efficiency for electric field frequencies of 500-1000 MHz is between 15 and 21 dB, and is averaged to 18 dB. The shielding efficiency for magnetic field frequencies of 0˜600 MH is between 3 and 10 dB, and is averaged to 6 dB; the shielding efficiency for magnetic field frequencies of 600˜1000 MHz is between 10 and 20 dB, and is averaged to 15 dB.

### Embodiment 2

### Electroplated with 2-Micrometer Copper

On a PMMA plastic material, meshed trenches with linewidth of 12 micrometers and line pitch of 290 micrometers using hot embossing method are formed, and a layer of silver glue in the meshed trenches is coated. In addition, increase the thickness of copper in the trenches to 2 micrometers using the copper electroplating technology. The electromagnetic-wave shielding effect thereof is as follows. The shielding efficiency for electric field frequencies of 0˜500 MHz is between 32 and 58 dB, and is averaged to 41 dB; the shielding efficiency for electric field frequencies of 500-1000 MHz is between 25 and 32 dB, and is averaged to 29 dB. The shielding efficiency for magnetic field frequencies of 0-600 MH is between 14 and 26 dB, and is averaged to 21 dB; the shielding efficiency for magnetic field frequencies of 600-1000MHz is between 26 and 40 dB, and is averaged to 36 dB.

### Embodiment 3

### Electroplated with 2-Micrometer Nickel

On a PMMA plastic material, meshed trenches with linewidth of 12 micrometers and line pitch of 290 micrometers using hot embossing method are formed, and a layer of silver glue in the meshed trenches is coated. In addition, increase the thickness of nickel in the trenches to 2 micrometers using the nickel electroplating technology. The electromagnetic-wave shielding effect thereof is as follows. The shielding efficiency for electric field frequencies of 0˜500 MHz is between 22 and 57 dB, and is averaged to 32 dB; the shielding efficiency for electric field frequencies of 500˜1000 MHz is between 16 and 22 dB, and is averaged to 19 dB. The shielding efficiency for magnetic field frequencies of 0˜600 MH is between 7 and 21 dB, and is averaged to 13 dB; the shielding efficiency for magnetic field frequencies of 600˜1000 MHz is between 21 and 27 dB, and is averaged to 24 dB.

### Embodiment 4

### Electroplated with 2-Micrometer Nickel-Cobalt

On a PMMA plastic material, meshed trenches with linewidth of 12 micrometers and line pitch of 290 micrometers using hot embossing method are formed, and a layer of silver glue in the meshed trenches is coated. In addition, increase the thickness of nickel-cobalt in the trenches to 2 micrometers using the nickel-cobalt electroplating technology. The electromagnetic-wave shielding effect thereof is as follows. The shielding efficiency for electric field frequencies of 0˜500 MHz is between 24 and 49 dB, and is averaged to 31 dB; the shielding efficiency for electric field frequencies of 500˜1000 MHz is between 20 and 24 dB, and is averaged to 23 dB. The shielding efficiency for magnetic field frequencies of 0-600 MH is between 1 and 14 dB, and is averaged to 7 dB; the shielding efficiency for magnetic field frequencies of 600˜1000 MHz is between 14 and 26 dB, and is averaged to 20 dB.

### Embodiment 5

### Electroplated with 5 Micrometer Copper

On a PMMA plastic material, meshed trenches with linewidth of 12 micrometers and line pitch of 290 micrometers using hot embossing method are formed, and a layer of silver glue in the meshed trenches is coated. In addition, increase the thickness of copper in the trenches to 5 micrometers using the copper electroplating technology. The electromagnetic-wave shielding effect thereof is as follows. The shielding efficiency for electric field frequencies of 0-500 MHz is between 49 and 53 dB, and is averaged to 51 dB; the shielding efficiency for electric field frequencies of 500˜1000 MHz is between 46 and 66 dB, and is averaged to 54 dB. The shielding efficiency for magnetic field frequencies of 0-600 MH is between 25 and 37 dB, and is averaged to 33 dB; the shielding efficiency for magnetic field frequencies of 600˜1000 MHz is between 37 and 57 dB, and is averaged to 50 dB.

### Embodiment 6

### Electroplated with 5-Micrometer Nickel

On a PMMA plastic material, meshed trenches with linewidth of 12 micrometers and line pitch of 290 micrometers using hot embossing method are formed, and a layer of silver glue in the meshed trenches is coated. In addition, increase the thickness of nickel in the trenches to 5 micrometers using the nickel electroplating technology. The electromagnetic-wave shielding effect thereof is as follows. The shielding efficiency for electric field frequencies of 0˜500 MHz is between 41 and 59 dB, and is averaged to 54 dB; the shielding efficiency for electric field frequencies of 500˜1000 MHz is between 41 and 79 dB, and is averaged to 51 dB. The shielding efficiency for magnetic field frequencies of 0˜600 MH is between 24 and 40 dB, and is averaged to 32 dB; the shielding efficiency for magnetic field frequencies of 600˜1000 MHz is between 32 and 50 dB, and is averaged to 44 dB.

### Embodiment 7

Electroplated with 5-Micrometer Nickel-Cobalt

On a PMMA plastic material, meshed trenches with linewidth of 12 micrometers and line pitch of 290 micrometers using hot embossing method are formed, and a layer of silver glue in the meshed trenches is coated. In addition, increase the thickness of nickel-cobalt in the trenches to 5 micrometers using the nickel-cobalt electroplating technology. The electromagnetic-wave shielding effect thereof is as follows. The shielding efficiency for electric field frequencies of 0˜500 MHz is between 25 and 41 dB, and is averaged to 31 dB; the shielding efficiency for electric field frequencies of 500˜1000 MHz is between 23 and 28 dB, and is averaged to 25 dB. The shielding efficiency for magnetic field frequencies of 0˜600 MH is between 1 and 1 5 dB, and is averaged to 7 dB; the shielding efficiency for magnetic field frequencies of 600˜1000 MHz is between 15 and 31 dB, and is averaged to 24 dB.

1. A manufacturing method of an electromagnetic shield layer for a plasma display panel, the steps thereof comprising:
Hot-embossing a substrate with a hot embossing machine to form a plurality of trenches on the substrate;
coating a conduction layer in the plurality of trenches; and
electroplating a metal layer on the conduction layer.

2. The manufacturing method in claim 1, wherein operating temperatures of the hot embossing machine are between 100 and 200° C. and pressures are between 1000 and 4000N.

3. The manufacturing method in claim 1, wherein after the step of coating the conduction layer, heat the temperature up to 70˜150° C. to dry the conduction layer off.

4. The manufacturing method in claim 1, wherein after the step of electroplating the metal layer, carry out a black oxidation process on the surface of the metal layer to form a black oxidation layer.

5. A structure of an electromagnetic shield layer for a plasma display panel, comprising:
a substrate, comprising a plurality of trenches on one side thereof;
a conduction layer, adapted in the plurality of trenches; and
a metal layer, adapted in the conduction layer.

6. The structure of claim 5, wherein the material of the substrate is chosen from the group consisting of polymethyl methacrylate, polycarbonate, polyethylene terephthalate, polyethyl, methylstyrene, and triacetate cellulose.

7. The structure of claim 5, wherein the trench widths of the trenches are between 6 and 50 micrometers, and the trench pitches thereof are between 150 and 500 micrometers.

8. The structure of claim 5, wherein the conduction layer is chosen from the group consisting of mixtures of copper, silver, nickel, gold, tin, platinum, palladium, iridium, cobalt, zinc, or alloys of the metal described above with glue.

9. The structure of claim 5, wherein the conduction layer further includes glue chosen from the group consisting of epoxy acrylic glue, silicon glue, polyimide glue, and mixtures of the glue.

10. The structure of claim 5, wherein the metal layer is chosen from the group consisting of copper, silver, nickel, gold, tin, platinum, palladium, iridium, cobalt, zinc, and alloys of the metal described above.

11. The structure of claim 5, wherein the thickness of the metal layer is between 1 micrometer and 15 micrometers.

12. The structure of claim 5, and further includes a black oxidation layer adapted on the metal layer.

13. The structure of claim 5, wherein the conduction layer is a black oxidation layer.

14. The structure of claim 5, wherein the trenches are geometric patterns with different or identical depths.

15. The structure of claim 5, wherein the trenches are meshed trenches.
